(19) United States
(12) Patent Application Publication
(10) Pub. No.: US 2009/0058074 A1
(43) Pub. Date: Mar. 5, 2009

(54) Blocking device

(76) Inventor: Osborn Persson, Halmstad (SE)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/664,920

(22) PCT Filed: Oct. 4, 2005
(86) PCT No.: PCT/SE05/01464

§ 371 Date: Nov. 10, 2008

(30) Foreign Application Priority Data
Oct. 11, 2004 (SE) 0402474-1

(51) Int. Cl. F16L 17/00

(52) U.S. Cl. 285/10

(57) ABSTRACT

The present invention relates to a device for blocking liquid and/or vapour flow from a hose and positioning of a hose breakage to a coupling in the hose, for example the end of the hose, at a nozzle, for example a pump nozzle, the coupling comprising a female part (1) and a male part (2, 16) which are releasably fixed in one another by means of a number of hooks (17), as well as a valve cone (11) which is disposed to block at least liquid flow out of the hose in the event that the female part (1) and the male part (2, 16) are separated from one another, the male part including an inner housing (2) which extends through an outer housing (16) which is axially movable on the inner housing (2), and the inner housing (2) supports the valve cone (11) and displays a valve seat which is intended for the valve cone (11) provided with through-flow openings (14).

The present invention relates to a device according to the preamble to appended Claim 1.

The number of self-service gasoline stations for refuelling vehicles is steadily increasing and the problems inherent in pump nozzles being forgotten in vehicle fuel pipes is constantly increasing also. In principle, there are no longer any other options than self-service stations. A forgotten pump nozzle results in most cases in a hose breakage, with the spillage of fuel into the ambient surroundings as a result, with all of the risks that such an accident involves both to the environment and to general safely. Further, there are ever more stringent environmental requirements placed on fuelling stations so as to avoid the spillage of both liquid and vapour from the various fuels. Known auxiliary aids for avoiding spillage in the event of a hose breakage are relatively cumbersome and suffer from a complicated design and construction, which in turn entails both a risk of unreliable operation, and above all high manufacturing costs, which greatly counteracts the application and use of such auxiliary aids.

The task forming the basis of the present invention is to realise an improvement to the device disclosed by way of introduction, above all by making it more versatile from the point of view of use.

This task is solved according to the present invention in that the device disclosed by way of introduction has been given the characterising features as set forth in the appended Claims.

The present invention realises a blocking device or a so-called hose breakage nozzle valve with relatively slight space requirements without jeopardising the contemplated function and reliability. The present invention moreover makes for the manufacture and assembly of the hose breakage nozzle valve at low cost. Moreover, re-use is prevented and use of the device according to the present invention is made possible in a plurality of different contexts, for example pumps for petrol (gasoline), pumps for diesel fuel, pumps for petrol with vapour recovery, and these different fields of application may be put into use with or without optics or spyglasses. This implies that many different needs may be satisfied using in principle one and the same model. That part of the device according to the present invention which makes possible the employment of optics or spyglasses is in principle identical with the same part without optics.

The present invention will now be described in greater detail hereinbelow, with reference to the accompanying Drawings.

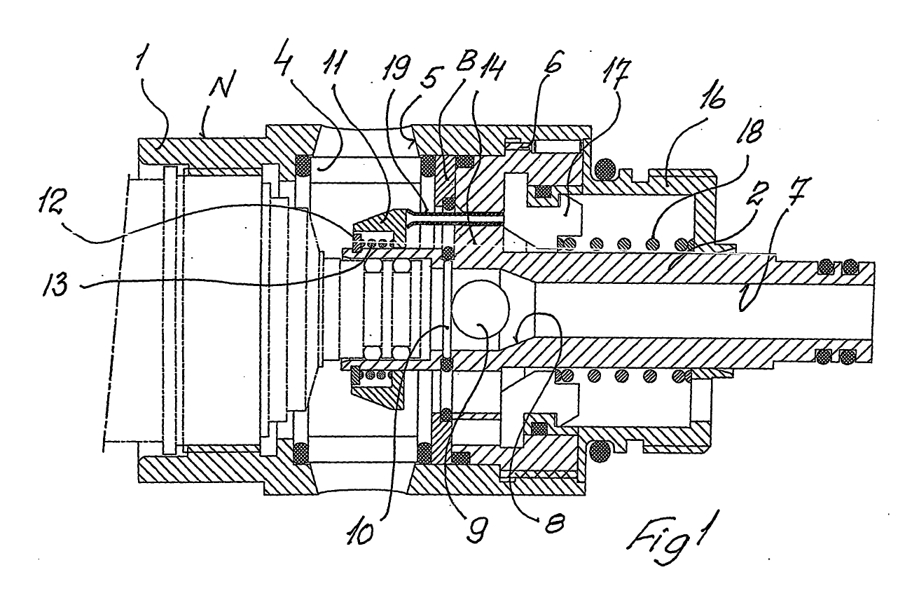

FIG. 1 is a longitudinal section through one embodiment of the device according to the present invention, only the one half of the parts being shown in FIG. 1.

FIG. 2 is a longitudinal section through a part of the device shown in FIG. 1.

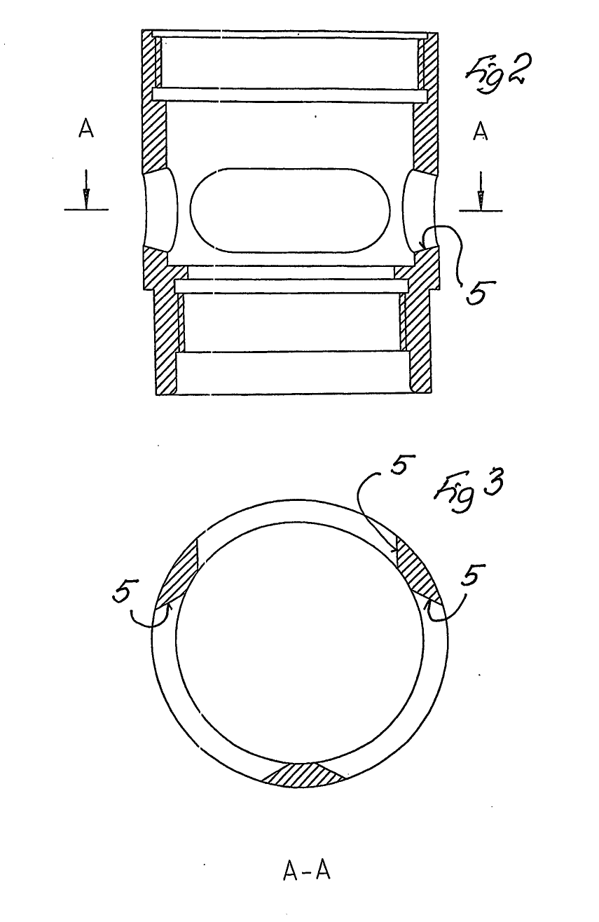

FIG. 3 is a section taken along the line in the direction of the arrows A-A in FIG. 2.

FIG. 4 shows a longitudinal section through another part of the device according to FIG. 1.

FIG. 5 is a section taken along the line in the direction of the arrows A-A in FIG. 4.

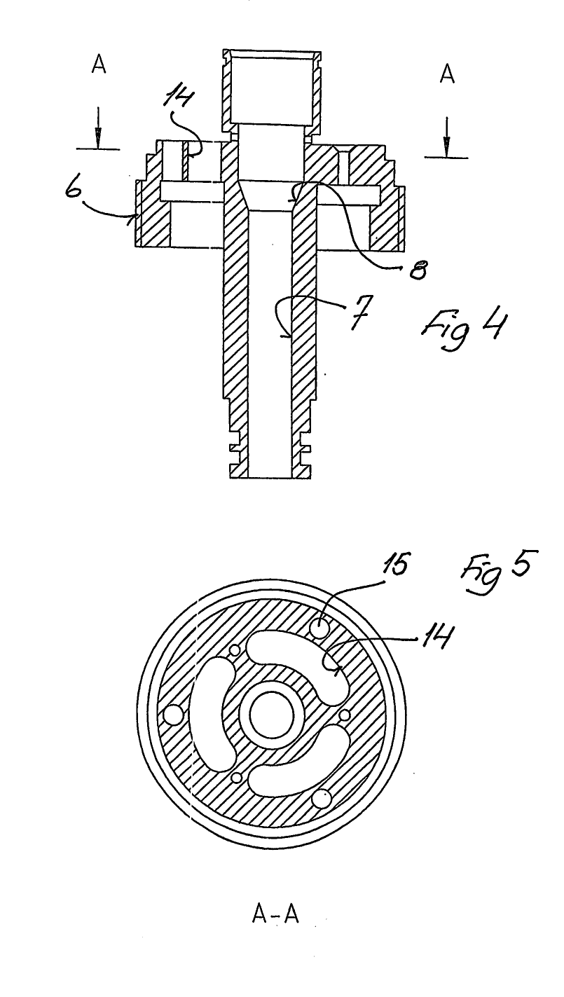

FIG. 6 is a longitudinal section through yet another part of the device according to FIG. 1.

FIG. 7 is a view from the right of the part according to FIG. 6.

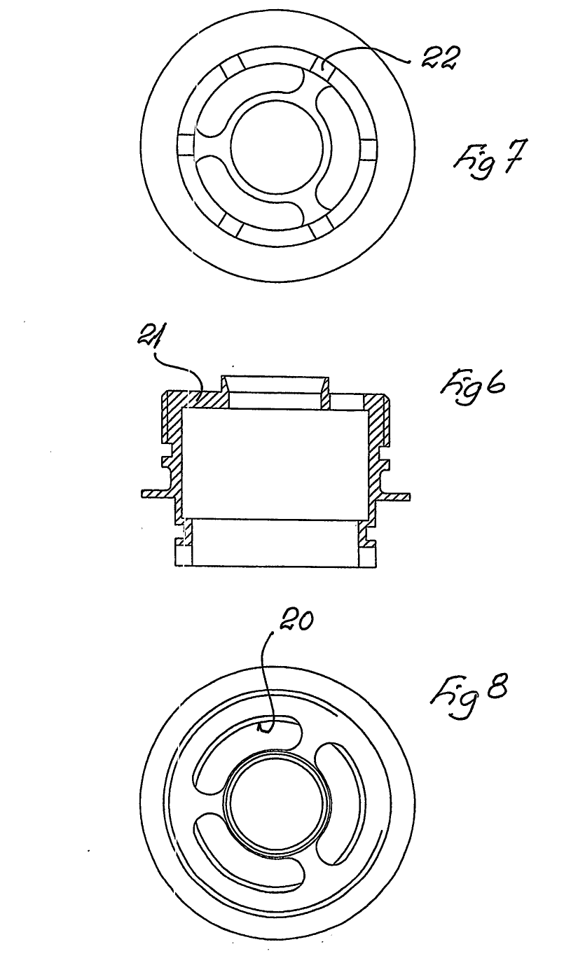

FIG. 8 is a view from the left of the part according to FIG. 6.

FIG. 9 shows, on a larger scale, a longitudinal section through a part of the device according to FIG. 1.

FIG. 10 is a section through still another part of the device according to FIG. 1.

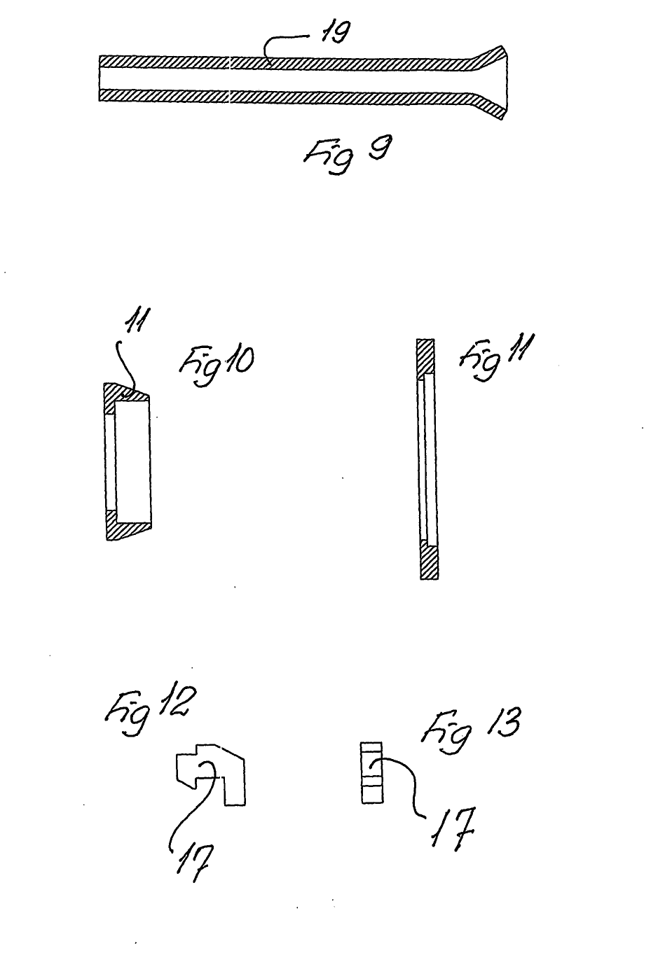

FIG. 11 is a section through yet another part of the device according to FIG. 1.

FIG. 12 is a view of still a further part of the device according to FIG. 1.

FIG. 13 is a view from the left of the part according to FIG. 12.

A device according to the present invention will be described hereinbelow in conjunction with its application as a hose breakage nozzle valve and with reference to Drawings 1 to 13, the same parts in the different Figures having been given the same reference numerals. The overview Figure shown in FIG. 1 shows one half of the parts in longitudinal section and the intention is that the device illustrated in FIG. 1 may be secured to the end of a hose by means of, for example, a thread union. In FIG. 1, parts of the end of the hose are intimated. At the opposite end of the device in FIG. 1, it is intended that a pump nozzle be placed and fixed on the device in FIG. 1 by means of a thread union.

The device illustrated in FIG. 1 has an outer housing 1 and an inner housing 2. The outer housing 1 is shown in greater detail in FIGS. 2 and 3. The outer housing has a thread union 3 for interconnection with a hose end in a per se known manner. The outer housing 2 shown in FIG. 2 is intended for a spyglass or optics 4 which is shown in FIG. 1. For the spyglass 4, the outer housing 3 has three recesses 5 which are disposed in the peripheral wall of the outer housing 1. At the opposite end of the outer housing 1 in relation to the hose end, there is provided a thread union 6 for anchoring the inner housing 2 in the outer housing 1. The inner housing 2 has a vapour passage channel 7 with a ball valve seat 8 and a valve ball 9 which is locked in the vapour recovery channel 7 by means of a pin 10 extending transversely through the vapour recovery channel 7. Thus, the ball valve will permit the flow of vapour from right to left in FIG. 1, while the ball valve prevents the flow of vapour from left to right through the channel 7.

On the end of the inner housing 2 located inside the outer housing 4, there is disposed a valve cone 11 which is kept in position on the end of the inner housing 2 by means of a locking ring 12 which engages in a groove on the inner end of the inner housing 2. Between the locking ring 12 and the valve cone 11, there is provided a compression spring 13 which serves to urge the valve cone 11 against a valve seat on the inner portion of the inner housing 7 and closure of the vapour through flow channel formed by a number of recesses 14 in the inner housing part 2. These recesses 14 are shown in greater detail in FIG. 5.

In the thread union 6 between the outer housing 1 and the inner housing 2, there is provided a pin 15 for preventing rotation of the parts in relation to one another after assembly. These are shown in greater detail in FIG. 5. Key surfaces N are to be found only on the outer housing 1.

On the opposite end of the device according to the present invention in relation to the hose end, it is provided with a female connection 16 through which the inner housing 2 extends and which is anchored in the inner housing 2 by means of hooks 17 as shown in greater detail in FIG. 12 and which are disposed with spacing around the housing and are urged towards the position illustrated in FIG. 1 by means of a compression spring 18. Between the hooks 17 and the valve cone 11, there are provided spacer rods 19 which are shown in greater detail in FIG. 9 and, as is apparent from the Drawing, may be in the form of tubes. The corner of the hooks 17 is curtailed in order to facilitate pivoting of the hooks 17 in a counterclockwise direction in FIG. 1, which is required for dismounting the parts from one another.

With the parts in the position illustrated in FIG. 1, the spacer rods 19 will hold the valve cone 11 in the open position, which thereby permits liquid flow through the outer housing 1 and the inner housing 2 as well as the male connections 1, 2 through the channels formed by the recesses 14 and out through the recesses 20 in the female connection 16.

On the exercise of a predetermined axial force between the male parts 1, 2 and the female part 16, the hooks 17 will be pivoted counterclockwise in FIG. 1 radially in relation to the inner housing 2 so that the upper shank of the hooks 17 leaves the groove on the inside of the inner housing 2 and entails a rupture of the anchorage between the male parts 1, 2 and the female part 16. If this takes place, the spring 13, will urge the valve cone 11 and the spacer rods 19 in an axial direction to the right according to FIG. 1 until the valve cone 11 closes the through-flow openings 14 in the inner housings 2, whereby the outward flow of liquid through the device is blocked. Such an axial force may occur if the pump nozzle is forgotten in the fuel pipe of the vehicle after refuelling.

FIG. 10 shows a vale cone 11 according to the present invention in slightly modified form in relation to the valve cone 11 in FIG. 1, and FIG. 11 shows a washer B which is disposed between the inner housing 2 and the spyglass 4.

Between the parts in the device according to FIG. 1, there are a number of sealing rings of the O-ring type which are illustrated by means of small circles. However, these should not be confused with the springs 13 and 18. Further, the female part 16 displays an outer thread 21 for the threading of a pump nozzle in position. The female part further displays milled portions 22 for the pin 15 and the hooks 17.

Many modifications are naturally conceivable without departing from the scope of the inventive concept as this is defined in the appended Claims.

1. A device for blocking liquid and/or vapor flow from a hose and positioning of a hose breakage to a coupling in the hose, at a nozzle, the coupling comprising a female part and a male part which are releasably fixed in one another by a number of hooks, as well as a valve cone which is disposed to block at least liquid flow out of the hose in the event that the female part and the male part are separated from one another, wherein the male part includes an inner housing which extends through an outer housing which is axially movable on the inner housing; and the inner housing supports the valve cone and displays a valve seat which is intended for the valve cone and is provided with through-flow openings.

2. The device as claimed in claim 1, wherein the inner housing has a vapor recovery channel with a ball valve which permits vapor through-flow and prevents liquid passage.

3. The device as claimed in claim 1, wherein the inner housing of the male part is anchored in the outer housing of the female part by a thread union.

4. The device as claimed in claim 3, wherein the thread union is locked by one or more pins.

5. The device as claimed in claim 1, wherein the outer housing of the male part is anchored in the female part by the hooks which extend between the inner housing of the female part and the outer housing of the male part and which are urged towards the anchorage position by a compression spring.

6. The device as claimed in claim 1, wherein the valve cone is urged to the open position against the action of a valve spring by rods which extend between the valve cone and the hooks.

7. The device as claimed in claim 5, wherein the hooks are switchable against the action of the compression spring to one position in which the anchorage between the parts ceases and the parts are separated from one another, and the valve cone is urged against the valve seat provided with through-flow openings by the valve spring.

8. The device as claimed in claim 1, wherein the outer housing of the female part is provided with a spyglass and recesses therefor.

9. The device as claimed in claim 2, wherein the vapor recovery channel includes a ball valve seat for a valve ball which is blocked at the ball valve seat by a pin extending through the vapour recovery channel.

10. The device as claimed in claim 5, wherein the valve cone is urged to the open position against the action of a valve spring by rods which extend between the valve cone and the hooks.

11. The device as claimed in claim 6, wherein the hooks are switchable against the action of the compression spring to one position in which the anchorage between the parts ceases and the parts are separated from one another, and the valve cone is urged against the valve seat provided with through-flow openings by the valve spring.
